(19) United States
(12) Patent Application Publication
(10) Pub. No.: US 2023/0068297 A1
(43) Pub. Date: Mar. 2, 2023

(54) DETERMINING FLOW RATES WITH THERMAL SENSORS

(71) Applicant: Hewlett-Packard Development Company, L.P., Spring, TX (US)

(72) Inventors: James A. Feinn, San Diego, CA (US); Mengqian Lu, San Diego, CA (US)

(73) Assignee: Hewlett-Packard Development Company, L.P., Spring, TX (US)

(21) Appl. No.: 17/795,371

(22) PCT Filed: Jan. 29, 2020
(86) PCT No.: PCT/US2020/015669

§ 371 Date: Jul. 26, 2022

(51) Int. Cl. B41J 2/125; B41J 2/045

(52) U.S. Cl. CPC B41J 2/125; B41J 2/04563

(57) ABSTRACT

A thermal inkjet printing device includes a fluidic die having a thermal sensor and a processor coupled to the fluidic die. The processor is to receive temperature data from the thermal sensor and determine a flow rate of liquid printing agent through the fluidic die based on the temperature data and an operating parameter for the fluidic die.

### BACKGROUND

In an inkjet printing system, an inkjet printhead prints an image by ejecting drops of a fluid (e.g., printing fluid) through a plurality of fluid nozzles onto a print medium, such as a sheet of paper. In other cases, the printing system ejects another fluid, such as a fluid for additive manufacturing (e.g., three-dimensional (3D) printing) onto a surface. The nozzles may be arranged in arrays or columns such that properly sequenced ejection of fluid from the nozzles causes characters and/or images to be formed on the print medium as the printhead and print medium move relative to each other. Thermal inkjet (TIJ) printheads eject the fluid drops by passing electrical current through a heating element, which serves as an actuator for the nozzle, to generate heat and vaporize a small portion of the fluid within a firing chamber. The rapidly expanding vapor bubble forces a small fluid drop out of the firing chamber. When the heating element cools, the vapor bubble quickly collapses, drawing more fluid from a reservoir into the firing chamber in preparation for ejecting another drop from the nozzle. Other printheads, such as piezo inkjet (PIJ) printheads, eject fluid drops by providing an electrical current to a piezoelectric element behind the nozzle, which ejects fluid from the nozzle.

Regardless of the type of printhead, during printing operations, a flow rate of fluid is controlled or regulated to maintain consistent print quality as well as consistent operation of the printhead. Thus, the inkjet printing system needs to determine the flow rate of fluid through its printhead.

### BRIEF DESCRIPTION OF THE DRAWINGS

Various examples will be described below referring to the following figures:

FIG. 1 shows a block diagram of a system in accordance with various examples;

FIG. 2 shows a bottom view of a printhead in accordance with various examples;

FIG. 3 shows a cross sectional view of the printhead of FIG. 2 in accordance with various examples;

FIG. 4 shows a block diagram of a fluidic module in accordance with various examples;

FIG. 5 shows a graph comparing average flow rates and average thermal sensor temperatures as a function of warming temperature and warming frequency in accordance with various examples;

FIG. 6 shows a graph of average thermal sensor temperatures as a function of average flow rates for various warming frequencies at a given warming temperature in accordance with various examples;

FIG. 7 shows a flow chart of a method for determining a fluid flow rate in accordance with various examples; and

FIG. 8 shows a block diagram of a computing system in accordance with various examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections.

As explained above, during printing operations, a flow rate of fluid is controlled or regulated to maintain consistent print quality as well as consistent operation of an inkjet printhead, which includes a fluidic die or, in some examples, a fluidic module comprising a plurality of fluidic dies. In some examples, the flow rate of fluid through the printhead is controlled for various reasons. For example, nozzle deprime may occur when the flow rate is too high, which causes a meniscus in the nozzle to be pulled down into the firing chamber, causing air ingestion and thus image quality and reliability issues. As another example, a too-low flow rate may cause the die temperature to increase more than is desired, which increases drop weight variation and/or consequent image quality variation. As another example, a too-low flow rate may lead to the formation of plugs (e.g., “decap”) in the nozzle area of the printhead; as a result, when the actuator is fired, initial drops of fluid are either not delivered (e.g., no fluid is expelled from the actuator) or misdirected toward the print medium. Further, in TIJ architectures, it is common to have some amount of air accumulate in the firing chamber, which is swept out of the chamber by the flow of fluid through the chamber; however, if the flow rate is too low, then the ability to clear air out of the firing chamber is reduced, which can result in degradation of print quality. Still further, spreading of fluid on the nozzle layer (e.g., “puddling”) may occur when a too-low flow rate increases the likelihood of meniscus overshoot from the firing chamber. In such a situation, increasing the flow rate increases the back pressure on the nozzle, which reduces the likelihood of meniscus overshoot, and thus puddling.

In addition to the above, other issues may be caused by irregular or poorly-regulated fluid flow rates. Thus, it is beneficial to determine and control the flow rate of fluid through a printhead. However, using a dedicated flow meter device to determine a flow rate of fluid through a printhead has several drawbacks, including being relatively expensive and bulky, which adds to the cost and packaging constraints of thermal inkjet printers.

Examples of the present disclosure address the foregoing with a fluidic die, for example, a printhead, that includes a thermal sensor (e.g., a thermal sense resistor (TSR)). A processor is coupled to the TSR and receives temperature data from the TSR. The processor determines a flow rate of fluid through the fluidic die based on both the temperature data and an operating parameter for the fluidic die. The operating parameter may include a target warming temperature for the fluidic die, a warming frequency for the fluidic die, or other attributes of the fluidic die during operation. In some cases, the fluidic die includes multiple TSRs and the processor determines the flow rate based on temperature data from a subset of the TSRs. In other examples, the printhead includes a fluidic module, which itself comprises a plurality of fluidic dies. Continuing this example, the processor may determine the flow rate through the fluidic module as a sum of flow rates through the fluidic dies of the module, which are determined as described above.

In some examples, the fluidic die includes a silicon substrate having a membrane region between a back side flow channel and a front side of the substrate. The membrane region facilitates positioning a TSR near the flow of fluid through the substrate. For example, by forming the membrane region in the silicon substrate of the fluidic die, a TSR is able to be positioned on the membrane region in much closer proximity to the flow of fluid through the fluidic die than is possible in arrangements where a membrane region is not present.

In some examples, the disclosed fluidic die includes a TSR disposed on a membrane region of the substrate of the fluidic die. The fluidic die may also include TSRs disposed on the substrate away from the membrane regions. During operation, the processor determines the flow rate of fluid through the fluidic die based on temperature data from a subset of the TSRs, which may include the TSR disposed on the membrane region, which is more closely thermally coupled to the fluid flowing through the fluidic die.

In some examples, the temperature measured on the fluidic die is proportional to the inverse of fluid flow rate through the fluidic die. For example, as fluid flow rate increases through the fluidic die, the temperature of the fluidic die decreases. However, the relationship between a measured temperature (e.g., by a TSR on the fluidic die) and a flow rate of fluid through the fluidic die may be dependent on operating parameters of the fluidic die, such as a target warming temperature for the fluidic die, a warming frequency for the fluidic die, or other attributes of the fluidic die during operation.

The described examples also pertain to establishing a working relationship between measured or sensed temperature (e.g., temperature data from TSRs) and fluid flow rate. In particular, a target warming temperature is established and a level of power is supplied to the fluidic die that is insufficient to reach that target warming temperature (e.g., below a threshold level needed to reach the target warming temperature). This ensures that power is constantly supplied to the fluidic die and also that no fluid is ejected from nozzles of the fluidic die, which simplifies the thermal system being considered (e.g., because no heat is dispelled from the system as fluid is ejected). A target warming temperature is selected that provides a large range of average flow rates and/or average TSR temperatures as a function of warming frequency, for example, relative to the ranges of average flow rates and/or average TSR temperatures as a function of warming frequency available for other target warming temperatures. Subsequently, for the selected target warming temperature, a warming frequency is selected that maximizes a range of corresponding flow rates for a given range of temperatures. Further, while reference is made to an example thermal inkjet printing system, certain examples of the present disclosure may also apply to other fluidic printing technologies, such as piezo inkjet and others.

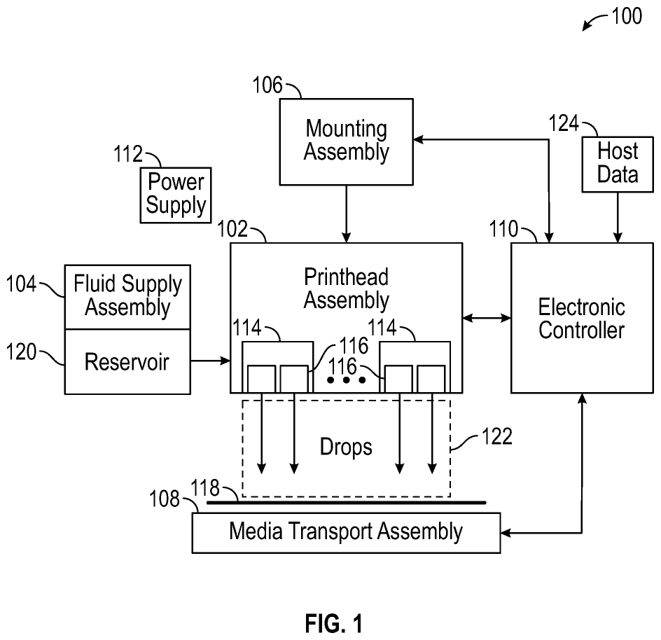

FIG. 1 illustrates a fluid ejection system 100, which in one example is an inkjet printing system suitable for incorporating a fluidic die as part of a fluid ejection assembly 114 as disclosed herein, according to an example of the disclosure. The fluidic die disclosed herein and described in accordance with various examples is not limited to use in an inkjet printing system, but rather may be utilized in any fluid ejection system 100, such as one for use in an additive manufacturing process. Fluid ejection system 100 includes a printhead assembly 102, a fluid supply assembly 104, a mounting assembly 106, a media transport assembly 108, an electronic controller 110, and a power supply 112 that provides power to the various electrical components of fluid ejection system 100. Printhead assembly 102 includes at least two fluid ejection assemblies 114 having a fluidic die that ejects drops of fluid through a plurality of orifices or nozzles 116 toward a print medium 118 so as to print onto print medium 118. In other examples, the printhead assembly 102 may only include a single fluid ejection assembly 114, however. The fluid ejection assembly 114 may be a printhead, a fluidic die, or other type of print module through which printing fluid flows. In addition to actuators for ejection of fluid (e.g., thermal resistors or piezo elements), other examples described herein may also include non-ejecting actuators. Example non-ejecting actuators may include microfluidic pumps to move fluid through fluidic channels. In one implementation, a non-ejecting actuator may include a firing element but no associated nozzle. Of course, the scope of this disclosure is not limited to a particular type (e.g., ejecting or non-ejecting) of actuator. Print medium 118 refers to any suitable type of material, such as paper, card stock, transparencies, Mylar, a 3D printing substrate (e.g., a bed of build material), and the like. Nozzles 116 may be arranged in columns or arrays such that properly sequenced ejection of fluid from nozzles 116 causes characters, symbols, and/or other graphics or images to be printed upon print medium 118 as printhead assembly 102 and/or print medium 118 are moved relative to each other.

Fluid supply assembly 104 supplies fluid to printhead assembly 102 and includes a reservoir 120 for storing fluid, such as printing fluid or fluid for additive manufacturing. Fluid flows from reservoir 120 to printhead assembly 102. Fluid supply assembly 104 and printhead assembly 102 can form a one-way fluid delivery system or a recirculating fluid delivery system. In a one-way fluid delivery system, substantially all of the fluid supplied to printhead assembly 102 is consumed during printing. In a recirculating fluid delivery system, however, a portion of the fluid supplied to printhead assembly 102 is consumed during printing. Fluid not consumed during printing is returned to fluid supply assembly 104.

In one example, printhead assembly 102 and fluid supply assembly 104 are housed together in an inkjet cartridge or pen. In another example, fluid supply assembly 104 is separate from printhead assembly 102 and supplies fluid to printhead assembly 102 through an interface connection, such as a supply tube. In either case, reservoir 120 of fluid supply assembly 104 may be removed, replaced, and/or refilled. In one example, where printhead assembly 102 and fluid supply assembly 104 are housed together in an inkjet cartridge, reservoir 120 may include a local reservoir located within the cartridge as well as a larger reservoir located separately from the cartridge. The separate, larger reservoir serves to refill the local reservoir. Accordingly, the separate, larger reservoir and/or the local reservoir may be removed, replaced, and/or refilled.

Mounting assembly 106 positions printhead assembly 102 relative to media transport assembly 108, and media transport assembly 108 positions print medium 118 relative to printhead assembly 102. Thus, a print zone 122 is defined adjacent to nozzles 116 in an area between printhead assembly 102 and print medium 118. In one example, printhead assembly 102 is a scanning type printhead assembly. In a scanning type printhead assembly, mounting assembly 106 includes a carriage for moving printhead assembly 102 relative to media transport assembly 108 to scan print medium 118. In another example, printhead assembly 102 is a non-scanning type printhead assembly. In a non-scanning printhead assembly, mounting assembly 106 fixes printhead assembly 102 at a prescribed position relative to media transport assembly 108. Thus, media transport assembly 108 positions print medium 118 relative to printhead assembly 102.

Electronic controller 110 may include a processor, firmware, and other printer electronics for communicating with and controlling printhead assembly 102, mounting assembly 106, and media transport assembly 108. Electronic controller 110 receives host data 124 from a host system, such as a computer, and includes memory for temporarily storing host data 124. Host data 124 may be sent to fluid ejection system 100 along an electronic, infrared, optical, or other information transfer path. Host data 124 represents, for example, a document and/or file to be printed. Using host data 124, electronic controller 110 controls printhead assembly 102 to eject fluid drops from nozzles 116. Thus, electronic controller 110 defines a pattern of ejected fluid drops which form characters, symbols, and/or other graphics or images on print medium 118. The pattern of ejected fluid drops is determined by the print job commands and/or command parameters from host data 124.

In one example, printhead assembly 102 includes one fluid ejection assembly 114. In another example, printhead assembly 102 is a wide-array or multi-head printhead assembly having multiple fluid ejection assemblies 114. In one wide-array example, printhead assembly 102 includes a carrier that carries fluid ejection assemblies 114, provides electrical communication between fluid ejection assemblies 114 and electronic controller 110, and provides fluidic communication between fluid ejection assemblies 114 and fluid supply assembly 104. In one example, fluid ejection system 100 is a drop-on demand TIJ printing system wherein fluid ejection assembly 114 is a TIJ printhead, such as described further below.

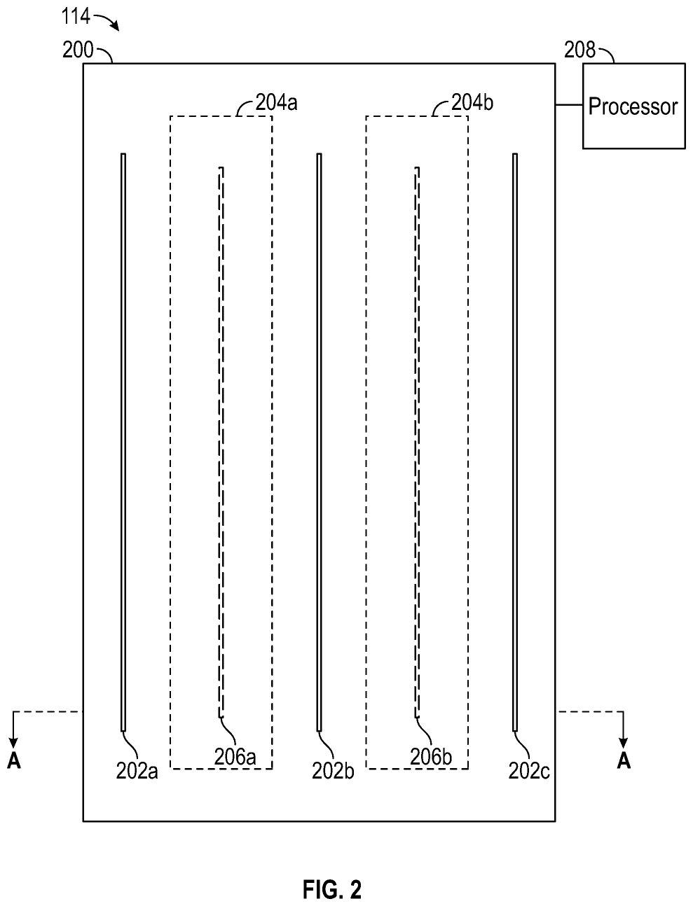

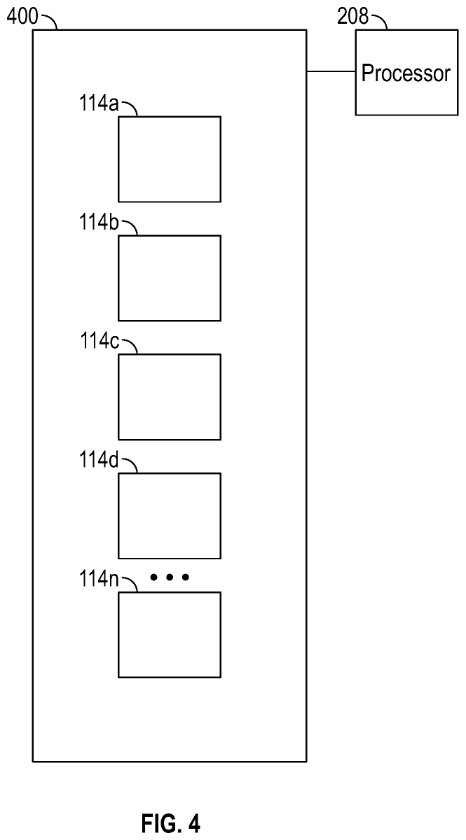

FIG. 2 shows a bottom view of a TIJ printhead as fluid ejection assembly 114 (referred to as a fluidic die 114 for simplicity), which includes a silicon fluidic die substrate 200. The fluidic die substrate 200 underlies a chamber layer having fluid chambers and a nozzle layer having nozzles 116 formed therein, as discussed below with respect to FIG. 4. However, for the purpose of illustration, the chamber layer and nozzle layer in FIG. 2 are assumed to be transparent in order to show the underlying fluidic die substrate 200.

In the example of FIG. 2, thermal sensors (e.g., TSRs) 202a, 202b, 202c are disposed on the fluidic die substrate 200. Further, in some examples, the fluidic die substrate 200 includes first membrane region 204a and second membrane region 204b. In still other examples, there may be more than two membrane regions 204 (and an underlying flow channel, described in further detail below), or one membrane region may extend across or span an underlying flow channel, also as described further below. Referring to the specific example of FIG. 2, additional TSRs 206a, 206b may be disposed on the first membrane region 204a and the second membrane region 204b, respectively. In these examples, the TSRs 202a, 202b, 202c are disposed on the fluidic die substrate 200 away from the membrane regions 204a, 204b. For example, the TSR 202a is disposed on the fluidic die substrate 200 on a side of the first membrane region 204a away from the second membrane region 204b; the TSR 202b is disposed on the fluidic die substrate 200 between the first membrane region 204a and the second membrane region 204b; and the TSR 202c is disposed on the fluidic die substrate 200 on a side of the second membrane region 204b away from the first membrane region 204a.

FIG. 2 also includes a processor 208 coupled to the fluidic die substrate 200 and, more particularly, the TSRs 202, 206 on the fluidic die substrate 200. In some cases, the electronic controller 110 functions as the processor 208, while in other cases, the processor 208 is a separate processing device relative to the electronic controller 110. Regardless of the specific implementation of the processor 208, the processor 208 receives temperature data from at least some of the TSRs 202, 206 and determines a flow rate of fluid through the fluidic die 114 based on the temperature data from the TSRs 202, 206 and an operating parameter for the fluidic die 114. The operating parameter may include a target warming temperature for the fluidic die 114, a warming frequency for the fluidic die 114, or other attributes of the fluidic die 114 during operation. The functionality of the processor 208 is described in further detail below.

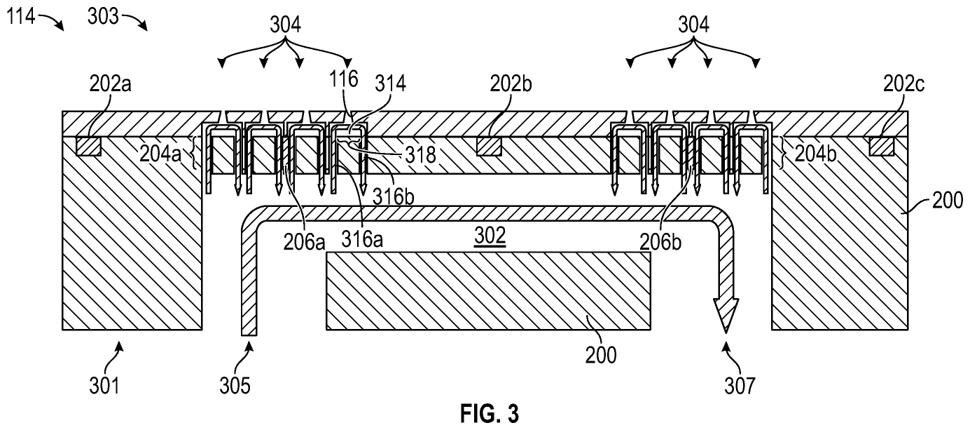

FIG. 3 shows a cross-sectional view of the fluidic die 114 taken along line A-A of FIG. 2, according to an example of the disclosure. The fluid ejection assembly 114 includes a silicon fluidic die substrate 200. A flow channel 302 through the fluidic die substrate 200 is part of a recirculating fluid delivery system. For example, printing fluid is provided to the fluidic die 114 at an inlet 305 of the flow channel 302, while unused printing fluid is recirculated from the fluidic die 114 at an outlet 307 of the flow channel 302. The flow channel 302 may, for example, extend into the plane of FIG. 3. In particular, the flow channel 302 is formed in a back side 301 of the fluidic die substrate 200. The flow channel 302 is in fluid communication with a fluid supply (not shown), such as a fluid reservoir. The fluidic die 114 includes drop generators 304, which, in one example, include a nozzle 116, a firing chamber 314, and a firing element 318 (which serves as an actuator for the nozzle 116) disposed in the firing chamber 314. Although drop generators 304 are shown as arranged toward the sides (e.g., near the inlet 305 and the outlet 307) of the flow channel 302, in other examples, the drop generators 304 may be arranged in a 2D array, including over the membrane regions 204a, 204b (and thus flow channel 302) as well. Nozzles 116 may be arranged in various manners, such as to form arrays extending into the plane of FIG. 3, for example toward the sides of the flow channel 302, or in a matrix array or pattern. The firing elements 318 may be, for example, thermal resistors.

During operation, a fluid drop is ejected from a firing chamber 314 through a corresponding nozzle 116 and the firing chamber 314 is then refilled with fluid circulating from flow channel 302 through a fluid feed hole (identified in FIG. 3 using numerals 316a and 316b). The fluid feed holes may also be divided into fluid feed inlets 316a, which provide fluid from the flow channel 302 to the firing chamber 314, and fluid feed outlets 316b, which return unused fluid (e.g., fluid not ejected) from the firing chamber 314 to the flow channel 302. More specifically, an electric current is passed through a firing element 318 resulting in rapid heating of the element. In response, fluid adjacent to the firing element 318 is superheated and vaporizes, creating a vapor bubble in the corresponding firing chamber 314. The rapidly expanding bubble forces a fluid drop out of the corresponding nozzle 116. When the firing element 318 cools, the vapor bubble quickly collapses, drawing more fluid into the firing chamber 314 in preparation for ejecting another drop from the nozzle 116.

In accordance with an example of this disclosure, the membrane regions 204a, 204b are positioned between the flow channel 302 and a front side 303 of the fluidic die substrate 200. The fluid feed holes 316 extend through the membrane regions 204a, 204b and are in fluidic communication with one of the flow channel 302 and the front side 303 of the fluidic die substrate 200. For example, the fluid feed holes 316 permit the flow of fluid from the flow channel 302 into the firing chambers 314, and permit the return of unused fluid from the firing chambers 314 to the flow channel 302. In other examples, there may be more than two membrane regions 204a, 204b, or one membrane region may extend substantially across the flow channel 302 (e.g., the membrane regions 204a and 204b are connected). For example, a single membrane region 204 including fluid feed holes may span the flow channel 302 to provide fluid communication from the flow channel 302 to the front side 303 of the fluidic die substrate 200.

In the absence of the membrane regions 204a, 204b in accordance with some examples of this disclosure, a fluid slot may extend through the fluidic die substrate 200. Such a fluid slot extending through the fluidic die substrate 200 prevents a TSR from being positioned near the flow channel 302 through the fluidic die substrate 200. For example, with the fluid slot extending through the fluidic die substrate 200, it is not possible to locate the TSRs 206a, 206b as shown, proximate to the flow of fluid through the flow channel 302, the fluid feed holes, the firing chambers 314, and out through the nozzles 116. While it would still be possible to locate the TSRs 202a, 202b, 202c as shown, if the fluid slot extends through the fluidic die substrate 200, the TSRs 202a, 202b, 202c are positioned away from the flow of fluid through the flow channel 302, the fluid feed holes, the firing chambers 314, and out through the nozzles 116. As a result, the TSRs 202a, 202b, 202c are relatively distant from the fluid flow, and thus data from those TSRs 202a, 202b, 202c may be at least partially uncorrelated to actual fluid temperature.

Thus, in accordance with examples of this disclosure, the membrane regions 204a, 204b facilitate the location of the TSRs 206a, 206b with greater proximity to the flow of fluid through the flow channel 302, the fluid feed holes, the firing chambers 314, and out through the nozzles 116. As a result, temperature data generated by the TSRs 206a, 206b is more closely coupled or correlated to the temperature of the fluid flowing through the fluid ejection assembly 114, and thus related to the flow of the fluid through the fluid ejection assembly 114 as well.

While FIGS. 2 and 3 have been described with respect to a fluidic die 114 containing a flow channel 302 having two associated membrane regions 204a, 204b, the examples of this disclosure are not limited to this particular numerical arrangement. For example, other examples may include a fluidic die having a single membrane region with a TSR disposed thereon, or multiple membrane regions, with a TSR disposed thereon. Still further, the number and position of the TSRs 202, 206 on the fluidic die substrate 200 may differ from that shown, and this disclosure is not limited in scope to the particular arrangement of TSRs 202, 206 described above with respect to FIGS. 2 and 3.

FIG. 4 shows a fluidic module 400 that includes multiple fluid ejection assemblies 114a-114n (referred to as fluidic dies 114 for simplicity, as above). In one example, the fluidic module 400 includes at least five fluidic dies 114a-114e. The fluidic module 400 itself may also be an example of a fluid ejection assembly 114, described above. The fluidic dies 114 of the fluidic module 400 may be similar to those described above with respect to FIGS. 2 and 3, although in some examples each of the fluidic dies 114 of the fluidic module 400 may not be identical. For example, the fluidic dies 114 of the fluidic module 400 may vary in the number of TSRs 202, 206 contained thereon; or the existence of and/or number of membrane regions 204 contained thereon. However, regardless of the particular configuration of the individual fluidic dies 114 themselves, in some examples a processor 208 is coupled to the fluidic module 400 and determines a flow rate through the fluidic dies 114, as explained above with respect to FIG. 2 (e.g., based on temperature data from the fluidic dies 114 and an operating parameter for the fluidic dies 114). The processor 208 also determines a flow rate through the fluidic module 400 as a sum of the determined flow rates through the fluidic dies 114 of the fluidic module 400.

As explained above, the temperature measured on a fluidic die 114 may be inversely proportional to the fluid flow rate through the fluidic die 114. For example, as fluid flow rate increases through the fluidic die 114, the temperature of the fluidic die 114 decreases. However, the relationship between a measured temperature (e.g., by TSRs 202, 206 on the fluidic die 114) and a flow rate of fluid through the fluidic die 114 may be dependent on operating parameters of the fluidic die 114, such as a target warming temperature for the fluidic die 114, a warming frequency for the fluidic die 114, or other attributes of the fluidic die 114 during operation.

Thus, in certain examples, it is beneficial to establish a working relationship between measured or sensed temperature (i.e., temperature data from TSRs 202, 206) and fluid flow rate. In particular, a target warming temperature is established and a level of power is supplied to the fluidic die 114 insufficient to reach that target warming temperature (e.g., below a threshold level needed to reach the target warming temperature). This ensures that power is constantly supplied to the fluidic die 114 and also that no fluid is ejected from nozzles 116 of the fluidic die 114, which simplifies the thermal system being considered (e.g., because no heat is dispelled from the system as fluid is ejected). A target warming temperature is selected that provides high sensitivity of fluid flow rate to changes in measured temperature. Subsequently, for the selected target warming temperature, a warming frequency is selected that maximizes a range of corresponding flow rates for a given range of temperatures.

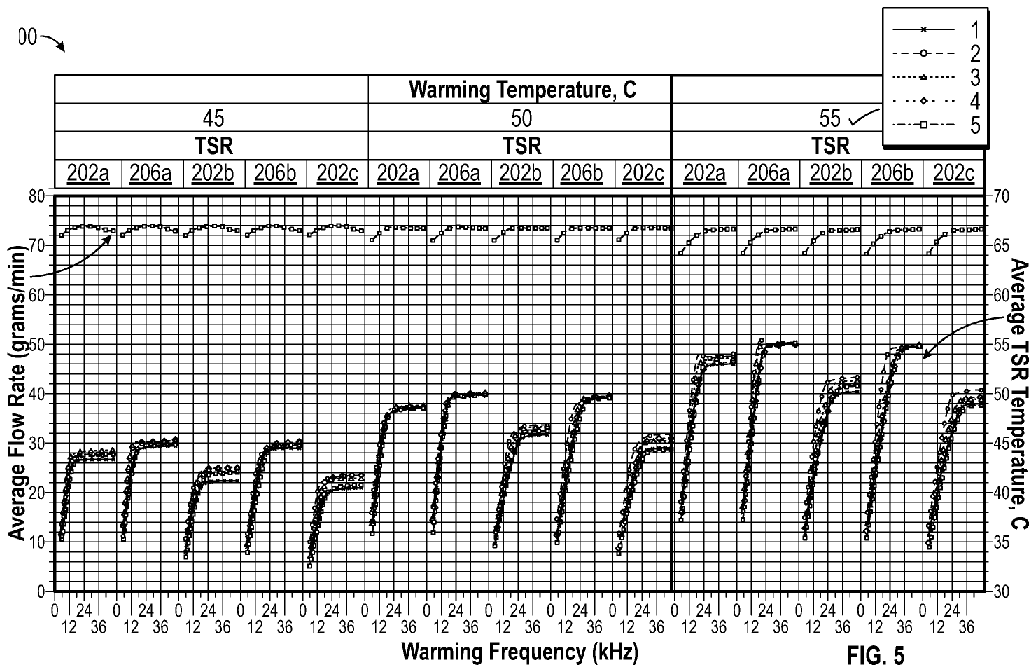

Turning to FIG. 5, a graph 500 is shown that depicts average temperature values from TSRs 202, 206 from five different fluidic dies 114 (e.g., making up a single fluidic module 400) along with average fluid flow rates through the fluidic module 400 (e.g., measured by a flow metering device). The average temperature values and fluid flow rates are shown for different target warming temperatures (e.g., 45 C, 50 C, and 55 C), as a function of warming frequencies at which pulses of energy are applied to the fluidic die 114 (e.g., ranging from approximately 6 kHz to 48 kHz), and different TSR locations on the fluidic dies 114, as shown by the TSR reference numerals 202a, 202b, 202c, 206a, 206b in FIG. 5. As explained above, for a given target warming temperature, a level of power is supplied to the fluidic die 114 insufficient to reach that target warming temperature, which ensures that power is constantly supplied to the fluidic die 114 and also that no fluid is ejected from nozzles 116 of the fluidic die 114.

To aid in establishing a relationship between data from the TSRs 202, 206 and fluid flow rates through a fluidic die 114 or a fluidic module 400, a target warming temperature may be selected for which average TSR temperatures and average flow rates demonstrate variability as a function of, for example, warming frequency. For example, a target warming temperature for which average TSR temperatures and average flow rates show little variability as warming frequency changes results in difficulty correlating TSR temperatures with average flow rates, since one or both values remain relatively constant even under varying operating parameters. In situations where average TSR temperatures and average flow rates show little variability as warming frequency varies, it is more difficult to relate measured TSR temperatures to flow rate. For example, when the warming frequency is sufficiently high that the measured TSR temperature reaches the target warming temperature, warming of the fluidic die 114 is turned off. When the warming of the fluidic die 114 is turned off, the fluidic die 114 begins to gradually cool until its temperature falls below a threshold temperature (e.g., 1 degree below the target warming temperature), at which point warming of the fluidic die 114 turns on again. This closed loop process continues for as long as warming is enabled. Under these conditions, the slope of average flow rate as a function of warming frequency (e.g., grams/min/kHz) will be approximately zero, because the warming power supplied to the fluidic die 114 is sufficiently high to reach and maintain the target warming temperature. For the purposes of the examples described herein, where temperature data from the TSRs 202, 206 is correlated to a flow rate through the fluidic die 114, a target warming temperature for which flow rate varies little as a function of warming frequency is not useful in determining the relationship, or correlation, between temperature data from the TSRs 202, 206 and the flow rate through the fluidic die 114.

A graphical example of the foregoing is demonstrated by the graph 500. In the graph 500, at a target warming temperature of 45 C, the range of average flow rates and range of average TSR temperatures as a function of warming frequency are both relatively small (e.g., a range of 20 C and 2 grams/minute over a range of warming frequencies). In particular, at a target warming temperature of 45 C, the average flow rates as a function of warming frequency are nearly constant, only varying by about 2 grams/minute from 72-74 grams/minute at varying warming frequencies. At a target warming temperature of 50 C, the range of average flow rates and the range of average TSR temperatures increase relative to those displayed at the target warming temperature of 45 C. However, at a target warming temperature of 55 C, the range of average flow rates as a function of warming frequency is the largest. Similarly, at the target warming temperature of 55 C, the range of average TSR temperatures as a function of warming frequency is the largest. Thus, in one example, a target warming temperature (e.g., 55 C) is selected that provides the largest range of average flow rate and/or average TSR temperatures across a range of warming frequencies, or as a function of warming frequency. By selecting a target warming temperature for which the average TSR temperatures and average flow rate values demonstrate greater variability as a function of warming frequency, a warming frequency may be selected (as described further below) that provides a relationship between sensed TSR values and flow rates having greater correlation and increased sensitivity (e.g., of sensed TSR values to changes in flow rate).

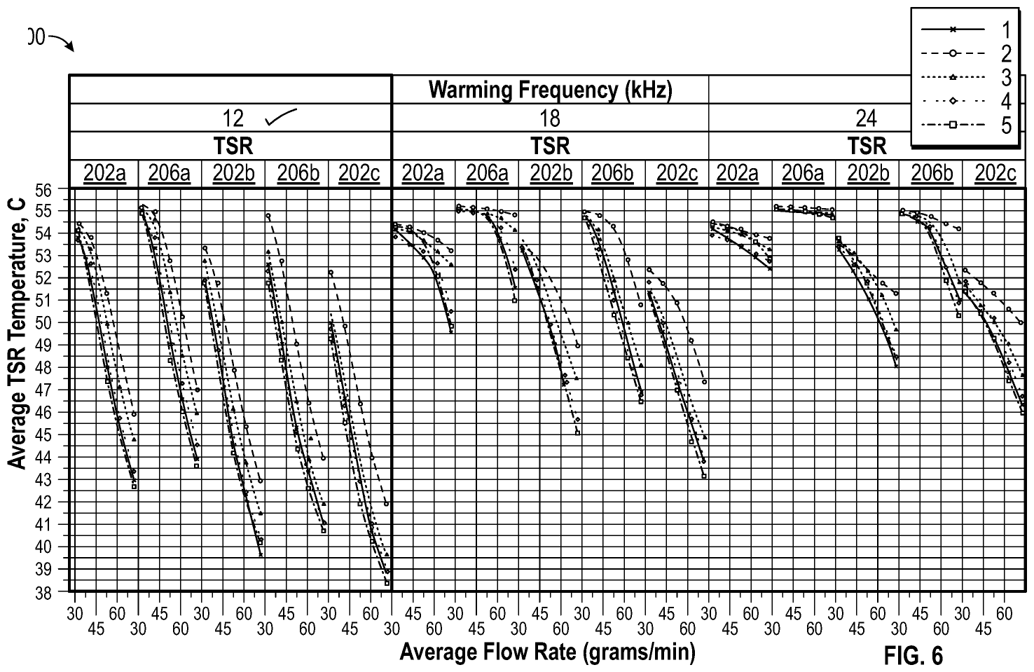

Turning to FIG. 6, once a target warming temperature is selected that provides high sensitivity of fluid flow rate to changes in temperature, as described above with respect to FIG. 5, a warming frequency is selected that maximizes or provides an increased slope of temperature as a function of flow rate, while also maximizing or providing an increased range of corresponding temperature values for a given range of flow rates. FIG. 6 shows a graph 600 that depicts average temperature values from TSRs 202, 206 from five different fluidic dies 114 (e.g., making up a single fluidic module 400) as a function of average fluid flow rates through the fluidic module 400 (e.g., measured by a flow metering device). The average temperature values as a function of fluid flow rates are shown for the example target warming temperature of 55 C, selected above with regard to FIG. 5. The average temperature values as a function of fluid flow rates are also shown for different warming frequencies (e.g., 12 kHz, 18 kHz, and 24 kHz) at which pulses of energy are applied to the fluidic die 114, and the different TSR locations on the fluidic dies 114, explained above.

As demonstrated by the graph 600, at a warming frequency of 24 kHz, the range of temperatures that correspond to a range of fluid flow rates from 30-75 grams/minute is relatively small, while the corresponding slope of temperature as a function of flow rate is also relatively small. For example, the temperature of the TSR 206a is nearly constant (e.g., a slope of approximately zero, and thus a correspondingly small range of temperatures that correspond to the range of flow rates) across the fluid flow rate range, while the temperature ranges of the other TSRs for that fluid flow rate range are relatively small. At a warming frequency of 18 kHz, the temperature ranges and slopes of temperature as a function of flow rate of the TSRs increase for the fluid flow rate range of 30-75 grams/minute. However, at a warming frequency of 12 kHz, the temperature ranges and slopes of temperature as a function of flow rate of the TSRs for the fluid flow rate range of 30-75 grams/minute through the fluidic module 400 are the largest. That is, at the warming frequency of 12 kHz, the temperature data from the TSRs is more sensitive to changes in flow rate through the fluidic module 400, which improves the accuracy of determining flow rate based on the temperature data from the TSRs.

Regardless of the particular target warming temperature selected (e.g., as explained above with respect to FIG. 5) and the warming frequency selected (e.g., as explained above with respect to FIG. 6), the processor 208 establishes a working relationship between the temperature data received from the various TSRs 202, 206 and a flow rate through the associated fluidic die 114 (or fluidic module 400, as a sum of the flow rates through its associated fluidic die substrates 200). For example, the relationships of FIG. 6 may also be determined for target warming temperatures of 45 C, 50 C, and other values. Further, the relationships of FIG. 6 may also be extended to other warming frequencies than the 12 kHz, 18 kHz, and 24 kHz examples shown. Thus, for a particular operating parameter or set of operating parameters for the fluidic die 114, such as target warming temperature and warming frequency, the processor 208 is able to determine a flow rate through the fluidic die 114 based on sensed temperature values from the TSRs 202, 206 on the fluidic die 114.

As explained above, the fluidic die 114 and its associated TSRs 202, 206 shown in FIGS. 2 and 3 is merely one example configuration. For example, the number and arrangement of TSRs may differ from that shown. Regardless of the number and arrangement of TSRs on a given fluidic die 114, in some examples of this disclosure, temperature data from a subset of TSRs on a fluidic die 114 are used to determine fluid flow rate through the fluidic die 114. In a particular example, the subset of TSRs includes the TSRs 206a, 206b located on the membrane regions 204a, 204b, which are more tightly coupled to the temperature of the fluid flowing through the fluidic die 114, as explained above.

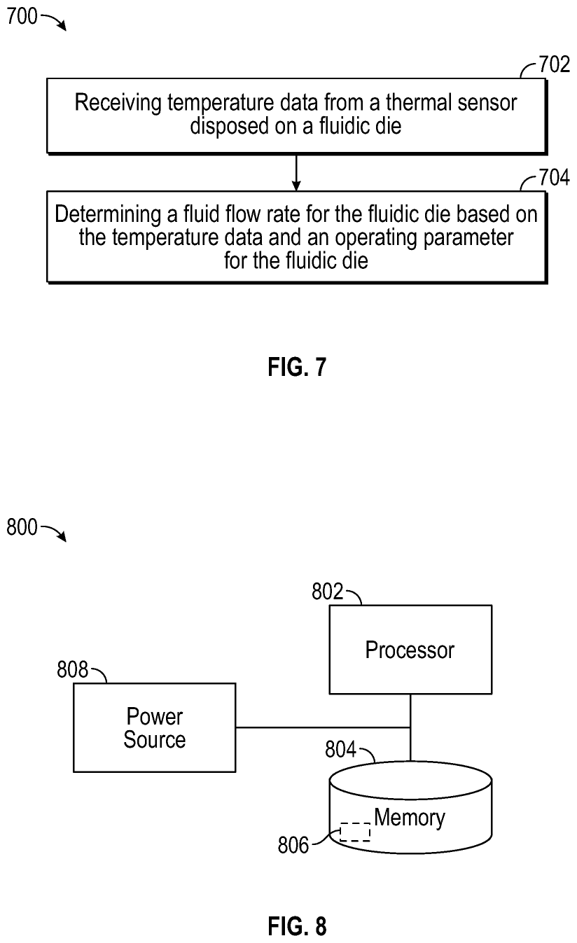

Turning to FIG. 7, a method 700 is shown in accordance with various examples. The method 700 is generally directed to determining a fluid flow rate through a fluidic die 114 based on temperature data received from a thermal sensor (e.g., one of TSRs 202, 206) disposed thereon, as explained above. In this example, the method 700 begins in block 702 with receiving temperature data from a thermal sensor disposed on a fluidic die 114.

The method 700 continues in block 704 with determining a fluid flow rate for the fluidic die based on the temperature data and an operating parameter for the fluidic die. As explained above, the relationship between a measured temperature (e.g., by TSRs 202, 206 on the fluidic die 114) and a flow rate of fluid through the fluidic die 114 may be dependent on operating parameters of the fluidic die 114, such as a target warming temperature for the fluidic die 114, a warming frequency for the fluidic die 114, or other attributes of the fluidic die 114 during operation. As a result, and as explained above, particular with regard to FIGS. 5 and 6, for a particular operating parameter or set of operating parameters for the fluidic die 114, such as target warming temperature and warming frequency, a flow rate through the fluidic die 114 is determinable (e.g., by the processor 208) based on sensed temperature values from the TSRs 202, 206 on the fluidic die 114.

Referring back to FIG. 4, in some examples the fluidic module 400 is part of a larger-scale fluid ejection system 100, such as a web press inkjet printing system. In some examples, a fluid supply valve (e.g., a needle valve) to the fluid ejection system 100 is manually adjusted by an operator to permit a particular flow rate of fluid from a fluid supply assembly 104 to the fluid ejection system 100. More specifically, the fluid supply valve is adjusted to set a flow rate to the fluid module 400 contained in the fluid ejection system 100. In accordance with examples of this disclosure, a target temperature is established that, for a given set of operating parameters (e.g., warming temperature and frequency, described above), corresponds to a desired flow rate set point for the fluid ejection system 100. Subsequently, with fluid supplied to the fluid ejection system 100 through the fluid supply valve, the operator may modulate the fluid supply valve while observing temperature data from TSRs 202, 206 of the fluidic module 400 of the fluid ejection system 100. When the observed temperature data corresponds, or is approximately equal, to the target temperature, it may be established that the fluid supply valve is appropriately adjusted for the desired application of the fluid ejection system 100. In this way, a fluid supply valve of a web press printing system (or other printing system that utilizes such a valve) may be adjusted based on temperature data from TSRs 202, 206 on fluidic module 400 of the fluid ejection system 100, rather than dedicated flow meters, which increase the cost and packaging complexity of printing systems as described above.

FIG. 8 shows a block diagram of an example computing system 800 to carry out some or all of the functionality described herein. For example, the computing system 800 includes a processor 802, which in some examples comprises the electronic controller 110 or the processor 208. The processor 802 is coupled to a memory 804, which in some examples comprises a non-transitory machine-readable medium. A power source 808 provides power to both the processor 802 and the memory 804. The processor 802 (e.g., microprocessor, central processing unit, or collection of such processor devices, etc.) executes machine-readable instructions 806 stored in memory 804, and upon executing the machine-readable instructions 806 in memory 804, performs some or all of the actions attributed herein to the electronic controller 110 or the processor 208. The memory 804 may comprise volatile storage (e.g., random access memory (RAM)), non-volatile storage (e.g., flash memory, read-only memory (ROM)), or combinations of both volatile and non-volatile storage.

As used herein, including in the claims, the word “or” is used in an inclusive manner. For example, “A or B” means any of the following: “A” alone, “B” alone, or both “A” and “B.”

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An inkjet printing device, comprising:
a fluidic die comprising a first thermal sensor; and
a processor coupled to the fluidic die, the processor to:
receive temperature data from the first thermal sensor; and
determine a flow rate of fluid through the fluidic die based on the temperature data and an operating parameter for the fluidic die.

2. The inkjet printing device of claim 1, wherein the operating parameter comprises a warming temperature for the fluidic die or a warming frequency for the fluidic die.

3. The inkjet printing device of claim 1, comprising a fluidic module comprising a plurality of fluidic dies, each of the fluidic dies comprising a thermal sensor, wherein the processor is to:
receive temperature data from the thermal sensors; and
determine a flow rate of fluid through the fluidic module based on the temperature data from the thermal sensors and an operating parameter for the fluidic module.

4. The inkjet printing device of claim 3, wherein the flow rate through the fluidic module comprises a sum of flow rates through the fluidic dies.

5. The inkjet printing device of claim 1, wherein the fluidic die comprises:
a flow channel formed in a back side of a substrate;
a membrane region positioned between the flow channel and a front side of the substrate;
a plurality of fluid feed holes in the membrane region, each fluid feed hole in communication with the flow channel and the front side of the substrate;
a second thermal sensor disposed on the membrane region of the substrate;
a third thermal sensor disposed on the substrate on a first side of the membrane region; and
a fourth thermal sensor disposed on the substrate on a second side of the membrane region,
wherein the processor is to:
receive temperature data from the thermal sensors; and
determine a flow rate of fluid through the fluidic die based on the temperature data from a subset of the thermal sensors and an operating parameter for the fluidic die.

6. The inkjet printing device of claim 1, wherein the first thermal sensor comprises a thermal sense resistor.

7. A method, comprising:
receiving temperature data from a thermal sensor disposed on a fluidic die; and
determining a fluid flow rate for the fluidic die based on the temperature data and an operating parameter for the fluidic die.

8. The method of claim 7, wherein the operating parameter comprises a warming temperature for the fluidic die or a warming frequency for the fluidic die.

9. The method of claim 8, comprising:
determining a relationship between the temperature data and the flow rate of fluid through the fluidic die by:
selecting a target warming temperature for the fluidic die;
applying a level of power to the fluidic die less than a threshold level of power sufficient to reach the target warming temperature; and
selecting a warming frequency that maximizes a range of temperature values that represent a range of flow rates.

10. The method of claim 7, comprising:
receiving temperature data from a plurality of thermal sensors disposed on a plurality of fluidic dies of a fluidic module; and
determining a flow rate of fluid through the fluidic module based on the temperature data from the thermal sensors and an operating parameter for the fluidic module.

11. The method of claim 10, wherein the flow rate through the fluidic module comprises a sum of flow rates through each of the fluidic dies.

12. A non-transitory, machine-readable medium containing instructions that, when executed by a processor, cause the processor to:
receive temperature data from a thermal sensor disposed on a fluidic die; and
determine a flow rate of fluid through the fluidic die based on the temperature data and an operating parameter for the fluidic die.

13. The non-transitory, machine-readable medium of claim 12, wherein the operating parameter comprises a warming temperature for the fluidic die or a warming frequency for the fluidic die.

14. The non-transitory, machine-readable medium of claim 12, wherein the instructions, when executed, cause the processor to:
receive temperature data from a plurality of thermal sensors disposed on a plurality of fluidic dies of a fluidic module; and
determine a flow rate of fluid through the fluidic module based on the temperature data from the thermal sensors and an operating parameter for the fluidic module.

15. The non-transitory, machine-readable medium of claim 14, wherein the flow rate through the fluidic module comprises a sum of flow rates through the fluidic dies.
